(19) United States
(12) Patent Application Publication
(10) Pub. No.: US 2022/0176421 A1
(43) Pub. Date: Jun. 9, 2022

(54) Plumbing Tool Support Accessory

(71) Applicants: Lawrence Mitchell, Cleveland, OH (US); Michael Bell, Bedford Heights, OH (US)

(72) Inventors: Lawrence Mitchell, Cleveland, OH (US); Michael Bell, Bedford Heights, OH (US)

(21) Appl. No.: 17/540,465

(22) Filed: Dec. 2, 2021

Related U.S. Application Data
(60) Provisional application No. 63/123,148, filed on Dec. 9, 2020.

(51) Int. Cl. B08B 9/045

(52) U.S. Cl. CPC B08B 9/045

(57) ABSTRACT

This present invention relates to a plumbing tool support accessory designed to support and stabilize a drain snake tool during a drain clearing process. The plumbing tool support accessory comprises at least two cutout grooves or notches along the rim of a bucket or other receptacle, such that the cutout grooves or notches are present diametrically opposite each other, thereby enabling the drain snake tool to be easily and securely placed in said grooves or notches. The plumbing tool support accessory of the present invention provides hands-free support to the drain snake tool and may also feature a cover having pockets to enable the user to keep smaller tools and equipment required for plumbing tasks stored therein.

### CROSS-REFERENCE TO RELATED APPLICATION

The present application claims priority to, and the benefit of, U.S. Provisional Application No. 63/123,148, which was filed on Dec. 9, 2020 and is incorporated herein by reference in its entirety.

### FIELD OF THE INVENTION

The present invention relates generally to the field of accessories for use with plumbing tools. More specifically, the present invention relates to a bucket or receptacle aide designed to support and stabilize an electric drain snake device while performing plumbing operations, such as clearing pipe drains and other outlets. More specifically, the accessory is a bucket-like device comprised of two or more grooves, slots, openings, or notches on diametrically opposite ends of the ring of the bucket, or other positions around the top or within the surface of the receptacle to hold handles or other items to stabilize the drain cleaning tool. In use, the tool along with the electric snake device is placed over the bucket or receptacle opening, top surface or ring, such that the body of the electric drain snake device properly fits over the bucket or receptacle opening or upper ring, thereby providing stability to the device for plumbing tasks. The electric drain snake holding bucket or receptacle supports the device without the user having to manually hold the device by hand during plumbing tasks, and saves extensive time and effort while performing the plumbing task. Additionally, the hands-free support enables those with limited physical dexterity to easily complete the plumbing task. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, various plumbing tools, such as drain snakes, pumps or the like are used to dislodge clogs and other blockages within plumbing lines. An electric drain snake, pump or plumber's snake is a relatively slender and flexible auger that may be driven into a drain pipe by an electric motor, or may be hand cranked to turn the auger. Drain snakes and similar tools are used to easily unclog any buildup of food, grease, debris, soap or other materials that may be blocking a drain. Specifically, the mechanical force provided by the electric motor or hand crank is used to twist the flexible cable in a clockwise or counter-clockwise direction to drive or move the cable, typically with an auger tip attached to the forward end thereof, through the drain pipe to clean it.

Usually, an electric drain snake tool is relatively heavy and requires physical agility and mobility to control the tool while performing a plumbing task, such as cleaning a drain. In addition, as the “snake” is unwound and moved into the drain, the tool can become unwieldy due to the additional torsional forces exerted by the snake in the drain or other pipes to unclog the drain. Accordingly, the electric drain snake tool may be difficult to use while performing the plumbing service, and may be particularly difficult to use for people with limited physical dexterity or if they are not able to use both hands to hold the tool while it is operation. In fact, some individuals with limited physical dexterity may not be able to utilize the tool at all, as they cannot handle the weight of the tool and may fail to stabilize the tool while performing the plumbing task. In addition, even for physically fit and capable individuals, the arms and hands of the individual can become tired quickly (due to the weight and unwieldiness of the drain cleaning tool), and may lead to destabilization of the tool during its operation. This, in turn, may lead to incomplete plumbing tasks and may cause injuries to the user as well.

Additionally, plumbing tasks oftentimes require that the drain snake device be used continuously for a period of time in order to fully remove the clog and not allow it to reset due to cessation of use, and individuals may prefer to take breaks due to tiredness by prolonged holding of the device. Taking breaks between the tasks may cause the plumber or the individual using the device to take a considerable amount of time to complete an individual plumbing task, leading to wasted time for both plumbers and the homeowners. Currently, use of the drain snake tools requires extensive time and effort on the part of plumbers to perform various plumbing tasks.

Therefore, there exists a long felt need in the art for a plumbing tool support accessory that can be used in combination with a plumbing tool such as a drain snake while performing plumbing tasks such as unclogging or clearing blockages from drains, and for an accessory to hold a drain snake tool while performing a drain-clearing operation. Additionally, there is a long felt need in the art for an electric or manual drain snake device support accessory that helps to stabilize the device while performing the plumbing tasks, and that eliminates the need for the user to hold the drain cleaning tool while performing the plumbing task. Moreover, there is a long felt need in the art for a plumbing tool support accessory that enables individuals with limited physical strength and/or dexterity to use a relatively heavy drain snake tool to unclog a drain, and that helps to prevent the physical strain associated with having to hold an drain snake device for a prolonged period of time. Finally, there is a long felt need in the art for a plumbing tool support accessory that is relatively inexpensive to manufacture and both safe and easy to use.

The subject matter disclosed and claimed herein, in one embodiment thereof, comprises a novel plumbing tool support accessory that is designed to support and stabilize a drain snake device and that comprises a receptacle with two or more cutout grooves, slots, openings or notches along the ring or opening of the bucket or receptacle. The cutout areas are disposed diametrically opposite to one another so that when the drain snake tool is placed on the bucket or receptacle the drain snake tool body securely rests on the two grooves or slots, thereby allowing the operator to use the drain snake without holding the tool by hand and provides the user with much greater stability during its operation.

In this manner, the novel plumbing tool support accessory of the present invention accomplishes all of the forgoing objectives, and provides a relatively easy, convenient and efficient solution to hold, position and stabilize the drain snake device or tool while performing a drain-clearing operation. The plumbing tool support accessory of the present invention is also user friendly, as it does not require the plumber or user to put much effort or labor into holding the relatively heavy electric drain snake device for a prolonged period of time while performing the plumbing task, and enables the task to be performed more quickly.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a novel plumbing tool support accessory or receptacle designed to support and stabilize an electric drain snake. The plumbing tool support accessory comprises a drain snake storage and support receptacle with at least two 30-degree cutout grooves, slots, openings or notches along its ring or along the opening of the bucket or receptacle. Each of the cutout grooves or notches is preferably present in diametrically opposite positions to each other. A drain snake tool is then placed over the opening of the receptacle and on the bucket rim in an orientation such that the drain snake tool body rests within the grooves, notches, openings or the like, thereby allowing an operator to use the drain snake without having to support the tool in their hands and with much greater stability.

In a further embodiment of the present invention, a kit comprising a handheld drain snake and a modified five-gallon bucket or other receptacle is disclosed. The modified five-gallon bucket or receptacle has a handle and at least two cutout grooves, slots, openings or notches along the rim or top surface of the bucket. The grooves, slots, openings, or notches stabilize the drain snake when the handheld drain snake is placed on the bucket and in the grooves while performing a plumbing task. The handheld drain snake is supported without having to hold it in the hands of the operator, thereby saving extensive time and effort during the plumbing task.

In yet a further embodiment of the present invention, a portable and lightweight drain snake bucket or receptacle for storing, transporting, supporting and/or holding a drain snake on the rim of the bucket while a plumbing task is being performed is disclosed. The bucket includes a five-gallon bucket, receptacle or tote with at least two and, in some instances, up to four grooves, slots, openings or notches. In one embodiment wherein only two grooves are present, each of the grooves are placed diametrically opposite to one another and along the direction perpendicular to the handle joints of the bucket, receptacle or tote. In the embodiment in which four grooves, notches, slots or openings are present, the grooves, slots or openings are present and perpendicular to each other such that two out of the four grooves are in alignment with the direction of the handle of the bucket or receptacle (i.e. each of the grooves, slots or openings is spaced apart approximately 90 degrees from one another along the bucket opening). A snake drain is then placed on the rim of the bucket or receptacle and in two of the four grooves, thereby providing for better stability and support while an operator performs the plumbing job with the device.

In a still further embodiment of the presently described invention, a method for plumbers and homeowners to utilize an electric drain snake quickly and effectively without having to hold the tool in their hands while performing a drain clearing operation is disclosed. The method comprises the initial steps of placing an electric drain snake tool on a rim of a five-gallon bucket or receptacle and over the opening of the bucket or receptacle. More specifically, the drain cleaning tool is positioned in a pair of notches, grooves, slots or openings present on the rim of the bucket or receptacle, wherein each of the two notches are diametrically opposite to one another. The drain snake tool is supported in the grooves, thereby avoiding the need to hold the tool in the hands and thus providing hands-free support to easily complete plumbing tasks. The drain snake tool is then used to perform the drain clearing operation, while being supported on the bucket. Once the drain clearing operation is complete, the drain snake is removed from the slots and placed in the bucket or receptacle wherein it may be stored until needed again, and/or transported to another job.

In a further embodiment of the present invention, a drain snake support and carrying bucket, tote or receptacle is disclosed and comprises at least two cutout notches, slots, openings or grooves on the upper ring or rim of the bucket for securely holding an electric drain snake over the opening while plumbing is performed. The receptacle provides a hands-free support for a user. A power cable feed lever of the electric drain snake is placed in one of the notches and the housing near the grip section of the electric drain snake is placed in the other notch for a stable placement of the electric drain snake on the bucket. An additional notch or slot may be provided to secure a further handle or support to further secure the tool in the opening of the tote or receptacle. In addition, a safety strap may be attached to the bucket or tote with a specifically designed hole or opening which may be in the sidewall of the bucket or tote to prevent the tool from moving out of the notches or slots such as may be encountered when rotational forces cause the tool to jump. In a further embodiment, latches may be placed over the slots or notches to secure the tool in position.

In yet a further embodiment, a cloth covering of the electric drain snake bucket of the present invention is also included, wherein the covering has a plurality of pockets (both interior and exterior to the bucket) to store various tools and other accessories that may be required or used for plumbing and cleaning clogged sinks, tubs and laundry drains. The bucket or receptacle is also useful for transporting and/or storing the drain snake tool.

The drain snake support bucket or receptacle of the present invention provides plumbers and homeowners with a hands-free support for the drain snake while performing a drain clearing operation. More specifically, users can place the drain snake over the opening of the bucket or receptacle and into the grooves which are utilized to both support and stabilize the device during the plumbing task. The movement of the drain snake is minimized while performing the task as the snake is securely placed and held in position with the help of the grooves or notches and their accompanying latches. Further, the grooves, notches, slots or openings are cut out in a manner such that the electric drain snake securely fits within the grooves, which may be of the same size or of different sizes. For example, one notch may be larger to accommodate the larger width of the back of the drain snake device, while the other notch may be narrower to receive the narrower end of the drain snake and ensure a relatively snug fit. Additionally, the opening or internal volume of the bucket or receptacle must be sufficiently deep and unencumbered so that the drain snake may rest in the notches while a portion of the tool body is disposed below the surface of the rim and a portion of the tool is above the surface of the rim.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a partial perspective view of one potential embodiment of the plumbing tool support accessory of the present invention in accordance with the disclosed architecture;

FIG. 2 illustrates a partial perspective view of one potential embodiment of the plumbing tool support accessory of the present invention in accordance with the disclosed architecture, wherein the accessory is supporting a drain snake apparatus;

FIG. 3 illustrates a partial perspective view of one potential embodiment of the plumbing tool support accessory of the present invention in accordance with the disclosed architecture, wherein the accessory is supporting an outer sleeve to protect the accessory and to store plumbing tools and other accessories therein; and

FIG. 4 illustrates a partial perspective view of one potential embodiment of the plumbing tool support accessory of the present invention in accordance with the disclosed architecture, wherein the accessory is supporting both a drain snake apparatus and an outer sleeve to protect the accessory and to store plumbing tools and other accessories therein.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a plumbing tool support accessory that can be used in combination with a drain snake device to unclog and/or clear a blockage from a drain, and for an accessory to hold the drain snake device while performing the drain clearing operation. There is also a long felt need in the art for an electric or manual drain snake device support accessory that stabilizes the device during its operation, and that does not require that the user hold the device for the entire operation, which could laborious and tiresome. Moreover, there is a long felt need in the art for a plumbing tool support accessory that enables individuals with limited physical strength and/or dexterity to use a relatively heavy drain snake tool to unclog a drain. Finally, there is a long felt need in the art for a plumbing tool support accessory that is relatively inexpensive to manufacture and both safe and easy to use.

The present invention, in one exemplary embodiment, is a novel plumbing tool support accessory designed to both support and stabilize a drain snake and that comprises a drain snake storage bucket having at least two 30-degree cutout grooves, slots, openings or notches along the rim of the upper edge of the bucket or receptacle. The cutout grooves, notches, slots or openings are preferably diametrically opposite to each other. A drain snake tool is then placed on the bucket in an orientation such that the drain snake tool body rests within, and is supported by, the two grooves, thereby allowing an operator to use the drain snake without having to hold the device in his or her hands for the entire operation, and with much greater stability.

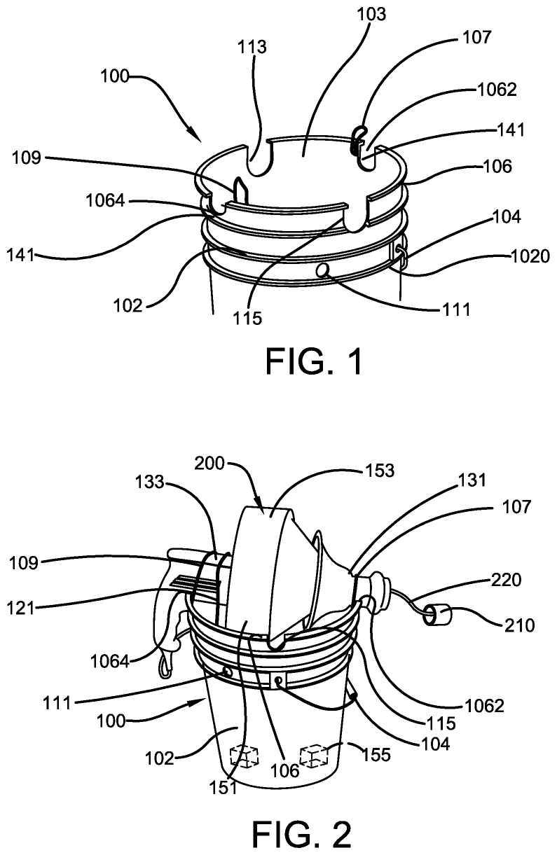

Referring initially to the drawings, FIG. 1 illustrates a partial perspective view of one potential embodiment of the plumbing tool support accessory or drain snake support 100 of the present invention in accordance with the disclosed architecture. More specifically, the drain snake support 100 is comprised of a body portion 102 similar to that of a conventional bucket and having a bottom (not shown), a continuous sidewall 1020 having a rim 106, each of which help to define an interior or opening 103. The drain snake bucket or support 100 is substantially cylindrical in shape with an open top surface and a rim or upper ring 106 on the top periphery of the sidewall 1020. While the FIGS. illustrates a cylindrical bucket like device, the invention is not so limited and the concepts of the present invention are also equally applicable to a tote or other receptacle, including those with different geometric shapes (e.g. rectangle, square, oval, etc.).

The plumbing tool support accessory 100 further comprises a handle 104 to easily carry the support accessory 100 from place to place and for convenient handling. Additionally, the support accessory 100 has at least two, and preferably four, approximately 30-degree notches, slots, openings or grooves 1062, 1064 in the rim 106 of the continuous sidewall 1020. The grooves 1062, 1064 in the rim 106 are preferably diametrically opposed to one another or disposed approximately 180 degrees apart along the rim 106. The two 30-degree notches 1062, 1064 can be used to securely place a drain snake tool or device 130 on the rim 106 of the support accessory 100. Each of the notches 1062, 1064 can be of the same width, or alternatively may be different widths to accommodate the different widths of the snake device 130. For example, the width of one such notch may be smaller in size than the other notch to receive the narrow width of the tool body or barrel end 131, wherein the other notch may be wider than the first notch to receive the larger end of the tool body or larger housing 133, as best shown in FIG. 2. Indeed, the wider notch 1062, 1064 is preferably between fifty and two hundred percent larger than the narrower notch 1062, 1064 in accordance with the sizing of most drain snakes 130.

Additionally, it should be appreciated that the two notches or grooves 1062, 1064 can be of similar depth and curvature and alternatively, can be of different size (depth or radius) and curvature. The different sizes can be made to securely place a smaller barrel end 131 or power cable feed lever of the took on one notch and a larger housing 133 near the grip section of the electric snake on the other notch. The rim may include additional notches 113 and 115 to provide further support for the drain snake 130, for example if a supplementary handle is attached to the sides of the drain snake 130. Each of the notches 1062, 1064 may also be provided with securing straps or latches 107 and 109 that can be used to hold and further secure the drain snake 120 in position, and avoid the drain snake 130 rocking out of the notches 1062, 1064 when it encounters rotational forces during the operation. FIG. 1 also illustrates a hole or opening 111 in the continuous sidewall 1020 of the support accessory 100 which can be used to latch a safety strap 121 (see e.g., FIG. 2) and add a further safety feature to the support accessory 100. The safety strap 121 may have elastic properties to allow the safety strap 121 to be stretched over different sized drain snakes 130.

The notches 1062, 1064, 113, 115 may be cut out to suit the conventional drain snakes currently available in the market, and to address the various requirements and needs of the user and/or plumber. The notches 1062, 1064, 113, 115 may also be provided with a rubber, urethane, polyurethane or other liner 141 to cushion the drain snake 130, and to provide some force absorbing characteristics to reduce the noise and vibration associated with the operation of the drain snake 130 while the same is being supported by the support accessory 100.

In one embodiment, the support accessory 100 is similar to a five-gallon storage bucket, and may be made up of a relatively hard and durable plastic or any other suitable material. More specifically, the bucket body 102 must be strong enough to firmly hold the drain snake tool 130 while in operation and capable of withstanding the vibrations associated therewith. When not in use during a drain-clearing operation, the support accessory bucket 100 can be used to both store and transport the drain snake 130 from one place to another. As stated above, the accessory bucket 100 is substantially cylindrical in shape with approximately the same bottom and top diameter dimensions. Further, the rim 106 has a diameter such that a conventional electric drain snake tool 130 can be easily and securely placed along the grooves 1062, 1064 (i.e., the drain snake 130 should easily span the diameter of the accessory bucket 100.

FIG. 2 illustrates a partial perspective view of one potential embodiment of the plumbing tool support accessory 100 of the present invention in accordance with the disclosed architecture, wherein the accessory is supporting a drain snake apparatus 130. More specifically, a handheld drain snake 200 (which is conventionally held in the operator's hands while performing a drain clearing operation) is securely placed on the rim 106 of the bucket 100 and in each of the cutout grooves 1062, 1064, such that the drain snake 200 spans the entire diameter of the support accessory 100. A plumbing job, such as cleaning a drain 210 using a cable 220 of the electric drain snake tool 200 is performed by a user very efficiently and easily while the drain snake tool 200 is positioned on the support bucket 100, and does not require the user to hold the drain snake tool 200 in his or her hands for a prolonged period of time, which can be both tiresome and laborious.

The support bucket 100 with grooves or notches 1062, 1064 in which the drain snake tool 200 is securely placed provides a solution for clogged sinks, tubs and laundry drains with the drain snake tool 200 supported and stabilized in a desired position on the bucket upper ring or rim 106. Further, the opening 103 of the support bucket 100 has enough of an interior depth to receive the lower portion 151 of the drain snake 200, while the upper portion 153 of the drain snake 200 extends above the upper ring or rim 106 of the bucket device 100. Accordingly, the available interior or depth of the opening 103 should be at least 6 inches and desirably up to 12 inches.

Additionally, the bottom of the support bucket 100 may also be provided with weights 155 (shown in phantom) to help hold the support bucket 100 in proper position when the snake drain 200 is in use. The weights 155 may be free standing weights placed in the bottom of the support bucket 100, or may be embedded in the bottom or continuous sidewall 1020 of the bucket support 100. In this manner, the support bucket 100 remains relatively still during the operation of the electric drain snake 200, even at speeds of up to 1,000 RPM. Further, the grooves 1062, 1064 do not tear or deteriorate even after multiple uses of the support bucket 100. The bucket 100 has a reasonable height which provides a comfortable position and height for the user to operate the drain snake 200 from, and once the job is complete the drain snake 200 can be put in the bucket for secure transportation from one place to the other by the user. The drain snake can further be secured in position by support straps or latches 107, 109 and 121, each of which are easily repositionable by the user.

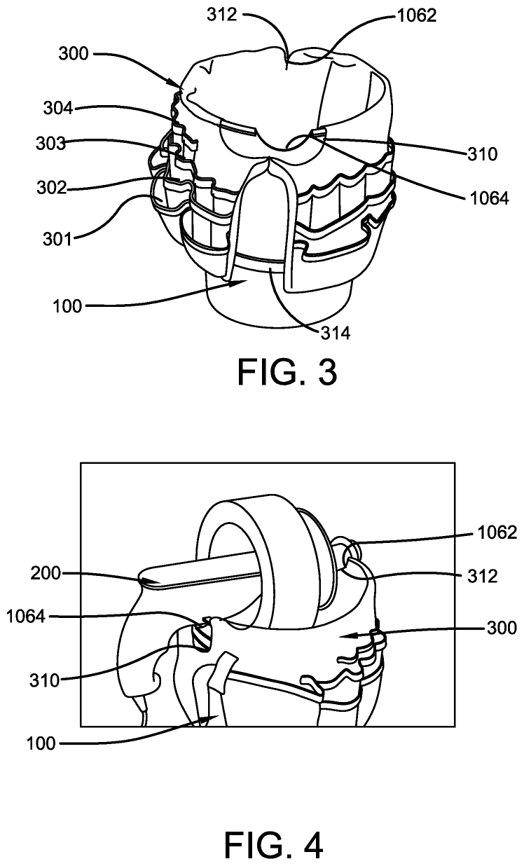

FIG. 3 illustrates a partial perspective view of one potential embodiment of the plumbing tool support accessory 100 of the present invention in accordance with the disclosed architecture, wherein the accessory 100 is supporting an outer sleeve or cover 300 to protect the accessory 100 and to store various plumbing tools and other accessories therein. More specifically, the cover 300 extends substantially over both the exterior of the continuous sidewall 1020 and extends into the interior of the opening 103. Additionally, the protective cover 300 comprises a plurality of pockets 301, 302, 303, 304 of various sizes and configurations to keep various plumbing tools such as, but not limited to, a drill holster, drill bits, hammers, drills, pry bars, screw driver, nails, screws, other accessories and other long-handled tools, which can be used during the plumbing job or operation. One or more of the various pockets 301, 302, 303, 304 may be positioned on the interior of the support accessory 100 and/or on its exterior so that the items stored therein are available for use even when a snake drain is being supported by the support accessory 100.

In a preferred embodiment of the present invention, the protective cover 300 has cutout portions 310, 312 for the grooves 1062, 1064 so that the electric drain snake 200 can be placed on the support bucket 100 while the electric drain snake 200 is positioned in said grooves 1062, 1064. The cover 300 may further comprise one or more logos, indicia, trademarks, geometric patterns, customizable colors and fonts, embroidery and prints and/or images on its surface, as well as an elastic band 314 at the bottom surface to securely protect and wrap around the support bucket 100. Nonetheless, there may be other fastening mechanisms, such as VELCRO®, zip ties, straps, etc., which may also be used for securing the cover 300 to the support bucket 100.

Additionally, the protective cover 300 is preferably waterproof, and comprised of a durable and machine washable material. For example, in one embodiment, the protective cover 300 is manufactured using a durable poly ripstop/600D poly material. Nonetheless, the material of the cover 300 is not so limited, and other materials can also be utilized to manufacture the cover 300 as per the preferences of the user and/or manufacturer. The cover 300 can also be used as a plumbing tool organizer and comprise between 10 and 60 pockets of different sizes. Nonetheless, the number of pockets positioned along the protective cover 300 is not so limited, and any number of pockets may be included as per the requirements of the user.

FIG. 4 illustrates a partial perspective view of one potential embodiment of the plumbing tool support accessory 100 of the present invention in accordance with the disclosed architecture, wherein the accessory 100 is supporting both a drain snake apparatus 200 and an outer sleeve or protective cover 300 to both protect the support accessory 100 and to store various plumbing tools and other accessories therein. As noted above, the support bucket 100 can be used in conjunction with the electric drain snake 200 even when the cover 300 is covering the support bucket 100. For example, the cover 300 may be positioned over the upper ring or rim 106 of the support bucket 100, except for the grooves or notches 1062, 1064 for which the cover 300 has cutouts 310, 312. The cutouts 310, 312 in the cover 300 allow a user to place the electric drain snake 200 on the bucket 100 in a way similar to when the electric drain snake 200 is placed on the bucket 100 without the cover 300 due to the presence of cutouts 310, 312. The cover 300 is provided over the bucket 100 in a way that cutouts 310, 312 coincide with the grooves 1062, 1064. As such, if the various grooves, notches, slots or openings are of different sizes, then the cover cutouts 310, 312 should also be of different sizes to accommodate the same.

In use, the electric drain snake 200 is placed on the support bucket 100 such that the trigger or ON/OFF switch of the electric drain snake 200 is easily operated by the user, and not obstructed by the sidewall 1020. Additionally, the support bucket 100 is of sufficient depth so that the electric drain snake 200 is easily accommodated therein, and the support bucket 100 does not interfere with the operation thereof. For example, the support bucket 100 preferably has a 11.80-12.5 inches diameter of the upper ring or rim 106, wherein the handle 104 is preferably affixed to the sidewall 1020 at 4.2-4.5 inches below from the rim 106. The handle 1204 may also have a grip for comfortable gripping by a user. In one embodiment, the bucket 100 comes with a lid (not shown) to cover the bucket 100 for protection when not in use. The bucket 100 can also have a 0.70-1.5 mil wall thickness, and can be painted to increase the aesthetic appeal of the bucket 100. The cable or cutter of the drain snake 200 can also be easily replaced without displacing the electric drain snake 200 from the support bucket 100.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “snake bucket”, “drain snake bucket”, “electric drain snake bucket”, “electric drain snake holder”, “electric drain snake holding bucket” and “electric drain snake storage bucket” are interchangeable and refer to the plumbing tool support accessory 100 of the present invention.

Notwithstanding the forgoing, the plumbing tool support accessory 100 of the present invention and its various components can be of any suitable size and configuration as is known in the art without affecting the overall concept of the invention, provided that it accomplishes the above stated objectives. One of ordinary skill in the art will appreciate that the size, configuration and material of the plumbing tool support accessory 100 and its various components as shown in the FIGS. are for illustrative purposes only, and that many other sizes and shapes of the plumbing tool support accessory 100 are well within the scope of the present disclosure. Although the dimensions of the plumbing tool support accessory 100 and its components are important design parameters for user convenience, the plumbing tool support accessory 100 and its components may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A plumbing tool accessory for use with a tool and comprising:
a bucket comprised of a bottom and a continuous sidewall extending upwardly from the bottom to form an interior, wherein the continuous sidewall further comprises a rim;
a first notch in the rim;
a second notch in the rim, wherein the second notch is positioned approximately 180 degrees from the first notch; and
a handle.

2. The plumbing tool accessory as recited in claim 1, wherein the first notch is larger than the second notch.

3. The plumbing tool accessory as recited in claim 2 further comprising a third notch in the rim.

4. The plumbing tool accessory as recited in claim 3 further comprising a fourth notch in the rim, wherein each of the first, second, third and fourth notches are spaced apart from the remaining notches by approximately 90 degrees.

5. The plumbing tool accessory as recited in claim 4 wherein each of the first and second notches further comprise a lining.

6. The plumbing tool accessory as recited in claim 5, wherein the lining comprises at last one of a rubber, a urethane and a polyurethane.

7. The plumbing tool accessory as recited in claim 6 further comprising at least one repositionable strap for covering the first notch.

8. The plumbing tool accessory as recited in claim 7 further comprising at least one opening in the continuous sidewall.

9. The plumbing tool accessory as recited in claim 1, wherein the first notch is larger than the second notch by between 50 and 200 percent.

10. The plumbing tool accessory as recited in claim 1 further comprising at least one weight positioned on the bottom of the bucket.

11. The plumbing tool accessory as recited in claim 1, wherein the height of the continuous sidewall, as measured from the bottom to the rim, is between 4 and 12 inches to accommodate a body portion of the tool.

12. The plumbing tool accessory as recited in claim 1 further comprising at protective cover.

13. The plumbing tool accessory as recited in claim 12, wherein the protective cover extends around both an exterior surface of the bucket and an interior surface of the bucket.

14. The plumbing tool accessory as recited in claim 13, wherein the protective cover comprises a plurality of pockets on each of an exterior surface and an interior surface.

15. The plumbing tool accessory as recited in claim 14, wherein the protective cover further comprises a first continuous opening and a second continuous opening, wherein the first continuous opening is positioned over the first notch and the second continuous opening is positioned over the second notch.

16. A drain cleaning system comprising:
a drain cleaning tool comprised of a body having a narrower end and a wider end;
a bucket comprised of a bottom and a continuous sidewall extending upwardly from the bottom to form an interior, wherein the continuous sidewall further comprises a rim having a first notch that is sized and configured to receive the narrower end of the body and a second notch that is sized and configured to receive the wider end of the body; and
a cover disposed over the continuous sidewall of the bucket and being comprised of a plurality of pockets, a first opening that is positioned over the first notch and a second opening that is positioned over the second notch.

17. The drain cleaning system of claim 16, wherein the cover is comprised of a waterproof material.

18. The drain cleaning system of claim 17, wherein each of the first notch and the second notch further comprise a lining material.

19. The drain tool and support as recited in claim 18, wherein the lining material is selected from a rubber, a urethane or a polyurethane.

20. A drain cleaning tool support accessory comprising:
a bucket having a rim, at least one sidewall, a bottom and an interior
a first notch in the rim;
a second notch in the rim, wherein the first notch has a size and a configuration that differs from the second notch;
a cover disposed over the rim of the bucket such that the cover substantially covers an exterior of the at least one sidewall and extends into the interior of the bucket, wherein the cover comprises a plurality of pockets and at least two openings corresponding to the first and second notches; and
a cover band for attaching the cover to the bucket, wherein the first and second notches are disposed approximately 180 degrees from one another along the rim of the bucket.
